(19) United States
(12) Patent Application Publication
(10) Pub. No.: US 2021/0331932 A1
(43) Pub. Date: Oct. 28, 2021

(54) PREPARATION AND APPLICATION OF 4-METHYL-5-VINYLTHIAZOLYL POLYMERIC IONIC LIQUID

(71) Applicant: FU ZHOU UNIVERSITY, Fuzhou, Fujian (CN)

(72) Inventors: Yuanyuan YUE, Quanzhou, Fujian (CN); Ben LIU, Quanzhou, Fujian (CN); Nangui LV, Quanzhou, Fujian (CN); Xiaojun BAO, Quanzhou, Fujian (CN); Jie LIU, Quanzhou, Fujian (CN); Tinhai WANG, Quanzhou, Fujian (CN); Pei YUAN, Quanzhou, Fujian (CN); Haibo ZHU, Quanzhou, Fujian (CN); Zhengshuai BAI, Quanzhou, Fujian (CN); Qingyan CUI, Quanzhou, Fujian (CN)

(73) Assignee: Fu Zhou University, Fuzhou, Fujian (CN)

(21) Appl. No.: 16/613,193

(22) PCT Filed: Dec. 27, 2018
(86) PCT No.: PCT/CN2018/124493

§ 371 Date: May 22, 2020

(30) Foreign Application Priority Data
Nov. 14, 2018 (CN) 201811355699.8

(51) Int. Cl. C01B 39/40; B01J 20/18; B01J 29/46; B01J 35/10; F01N 3/20; F01N 3/08; B01J 6/00; B01J 37/04; B01J 37/06

(52) U.S. Cl. CPC C01B 39/40; B01J 20/18; B01J 29/46; B01J 35/10; F01N 3/2066; B01J 2220/4806; B01J 6/001; B01J 37/04; B01J 37/06; F01N 2370/04; F01N 3/0842

(57) ABSTRACT

This invention belongs to the technical field of green preparation of environmentally friendly catalysts, and discloses a preparation method and application of mesoporous FeCu—ZSM-5 molecular sieve, in particular to a method for synthesizing mesoporous FeCu—ZSM-5 molecular sieve by one-pot method and the application in selective catalytic reduction (SCR) denitration reaction. This invention firstly proposes to combine the two calcinations after demolding and ion exchange into one, that is, the original powder is directly calcined to prepare a FeCu—ZSM-5 molecular sieve. The molecular sieve has several advantages such as window with wide temperature window, low cost, good hydrothermal stability and high SCR denitrification activity. Besides, the synthesis process does not use a (large) pore template, nor does it use a post-treatment method to construct the mesopores. Therefore, the method of the invention not only has the advantages of simple process, simple operation, but also good economic and environmental benefits.

### FIELD AND BACKGROUND OF THE INVENTION

This invention belongs to the field of environmentally friendly catalysts, and particularly relates to a preparation method of mesoporous FeCu—ZSM-5 molecular sieves and the application in the selective catalytic reduction of NOₓ.

At present, nitrogen oxides have become the most important atmospheric pollutants except respirable particulate matter and sulfur dioxide, which are mainly from catalytic cracking (FCC) flue gas, automobile exhaust gas and thermal power plant emissions. In recent years, NH₃—SCR denitration technology has gradually become the focus of research, and is considered by many experts and scholars as the most potential denitration technology. Molecular sieves have the characteristics of regular ordered structure, adjustable skeleton composition, high specific surface area, adsorption capacity and cation exchangeability, good pore shape selection, excellent thermal stability and chemical stability, which is widely used in petrochemical, fine chemical and green chemical industries. In recent years, the hetero atom modified ZSM-5 molecular sieve has become one of the hotspots in the field of environmental protection, especially the ZSM-5 molecular sieve modified by Fe or Cu has broad application prospects in the field of denitration.

CN201610320403.3 had published a preparation method and application of a Fe-ZSM-5 doping Rh and Er composite catalyst. The sodium-type high silicon-aluminum ratio Na-ZSM-5 molecular sieve was prepared by hydrothermal method, and exchanged with NH4Cl solution to prepare NH4-ZSM-5 molecular sieve, then NH₄—ZSM-5 molecular sieve was added to the ferric nitrate solution to prepare Fe-ZSM-5 molecular sieves by exchange method. Then, a composite Rh/Er/Fe % ZSM-5 catalyst with high specific surface area (350˜420 m²/g) was prepared through doping a small amount of Rh and Er. Although this catalyst has a high initial conversion rate of NO in a certain temperature range, its preparation process is complicated, and its conversion to ammonia type molecular sieve by sodium type molecular sieve not only has high energy consumption, but also faces environmental problems. With the continuous improvement of environmental protection requirements, ammonia emissions face enormous challenges, and the use of rare metals still faces a series of problems of high cost and low resources.

CN201711364463.6 disclosed a method for preparing Cu-ZSM-5 by ion exchange. This invention employs a combination of a liquid phase ion exchange method and a solid phase dispersion method. First, the copper nitrate solid and the HZSM-S molecular sieve raw powder were weighed in a mass ratio and thoroughly ground and mixed in a mortar. Then, it was transferred to absolute ethanol/distilled water, stirred and rapidly mixed to prepare a suspension. Ion exchange was carried out by heating in an ultrasonic wave, and then a small amount of liquid was obtained by vacuum distillation. The above small amount of liquid was transferred to a crucible and placed in an oven to dry to a solid state. The sesbania cannabina powder and the above solid were ground in a container, and a mixture of absolute ethanol/distilled water was added dropwise to a dough. It was then pressed into a sheet-like solid of uniform thickness and dried in an oven. The dried sheet-like solid was crushed, sieved, placed in a microwave muffle furnace, heated and calcined, and naturally cooled. The invention has the characteristics of good dispersibility of copper ions and high decomposition rate of NO, but its complicated preparation method inevitably faces a series of obstacles on the road of industrialization. At the same time, this method has the disadvantage of low atomic utilization, and the method of solid phase liquid phase separation still faces the challenge of industrialization.

CN201310371632.4 disclosed a preparation method of Cu—Fe-ZSM-5-concave composite flue gas denitration catalyst. First, the concave soil is subjected to calcination, hot acid treatment, suction filtration, and water washing to obtain acidified concave soil. Subsequently, the lye and the organic template are added, and the ZSM-5 molecular sieve is prepared by aging, hydrothermal crystallization, suction filtration, water washing, drying, and calcination. Then, the mixture of ZSM-5 molecular sieve and the mixture of concave soil, copper salt and iron salt is mixed and stirred, heated and refluxed, dried, extruded, calcined to prepare Cu—Fe-ZSM-5-concave composite flue gas denitration catalyst. Although this method utilizes the concave carrier and viscous properties, it utilizes the adsorption characteristics of ZSM-5 for NO, and introduces cheap iron salts to reduce the cost, but its temperature window is narrow, denitrification activity was exhibited only in the range of 250-330° C. Its temperature window obviously does not meet the development trend of the future denitrification field.

At present, the preparation of FeCu—ZSM-5 molecular sieves is carried out by ion exchange of the synthesized molecular sieves with Fe salts and Cu salts. This method is not only cumbersome in steps, high in energy consumption, but also has a narrow denitrification window (mainly low temperature denitration activity). At the same time, the impregnation of heteroatoms tends to agglomerate on the surface of the molecular sieve, hinder the pores, and block the active sites. Therefore, if one-pot method and low-cost in-situ synthesis technology of high-performance mesoporous FeCu—ZSM-5 molecular sieve can be developed on the basis of using cheap templating agent, it is expected to obtain molecular sieves with suitable active site distribution, low cost, high denitrification performance. This possess an important scientific research value, and broad industrial application prospects.

### SUMMARY OF THE INVENTION

In order to solve the above problems, the present invention provides a method for preparing a mesoporous FeCu—ZSM-5 molecular sieve. Under the condition of no use of the (large) pore templating agent and no post-treatment, this method uses a one-pot method of segmentally regulating the pH value of the synthetic system to synthesize mesoporous FeCu—ZSM-5 molecular sieve in situ. This method can directly perform ion exchange without removing the microporous template, and the prepared molecular sieve has a wide temperature window and adjustable Fe and Cu contents. Moreover, the Fe content in the molecular sieve framework is much higher than that of the pores and the surface, and copper exists mainly in the divalent form, and there is no agglomerated copper oxide, which means that most of the iron and copper in the molecular sieve exist in the form of denitration active sites.

A mesoporous FeCu—ZSM-5 molecular sieve, comprising: deionized water, aluminum source, silicon source, iron source, copper source, acid source and templating agents; the content of Fe₂O₃ in the molecular sieve is 0.1˜10% of the total weight of the molecular sieve, wherein the content of Fe in skeleton accounts for more than 95% of the total iron content, and is evenly distributed in the framework; the CuO content in the molecular sieve is 0.1˜10% of the total weight of the molecular sieve, wherein the content of Cu²⁺ accounts for more than 90% of the total copper content, and is evenly distributed on the inner surface of the molecular sieve.

The process for producing mesoporous FeCu—ZSM-5 molecular sieve includes a chemical reagent synthesis method or a mineral synthesis method.

The chemical reagent synthesis method specifically includes the following steps:

(1) the deionized water, aluminum source, silicon source, iron source, copper source and templating agent are uniformly mixed under stirring conditions at 20˜90° C., wherein the molar ratio of each substance in the synthetic system is SiO₂/Al₂O₃=10˜∞, SiO₂/Fe₂O₃=10˜350, SiO₂/CuO=10˜150, Na₂O/SiO₂=0.1˜0.5, H₂O/SiO₂=10˜50, templating agent/SiO₂=0.01˜0.5; after mixing, add the acid source to adjust the system pH to 5˜13 to carry out the first aging, then add the acid source again, adjust the system pH to 5˜13 to carry out the second aging, that is, obtain the aging gel,

(2) the aged gel obtained in the step (1) is transferred to a Teflon-lined reaction kettle for sealing crystallization, after crystallization, the product is cooled, filtered to remove the mother liquid, and the filter cake is washed with deionized water to neutrality, dried to obtain a solid, and then which the solid is passed through ion-exchange, filtered, washed, and dried to obtain a powder;

wherein the drying condition is 80-150° C., drying overnight;

(3) the powder obtained in the step (2) is placed in a muffle furnace and calcined to obtain a mesoporous FeCu—ZSM-5 molecular sieve.

Wherein the iron source is one or more of ferric nitrate, ferric chloride and ferric sulfate.

the copper source is one or more of copper nitrate, copper nitrate trihydrate, copper nitrate nonahydrate and copper chloride dihydrate.

the acid source is one or more of 2-Hydroxy-1,2,3-propanetricarboxylic acid, sulfurous acid, nitrous acid, sulfuric acid, hydrochloric acid, nitric acid, oxalic acid, acetic acid.

the silicon source is one or more of water glass, silica sol, tetraethyl orthosilicate, solid silica gel.

the aluminum source is one or more of sodium aluminate and aluminum sulfate.

the templating agent is tetraoctyl ammonium bromide, tetrabutylammonium bromide, CTMAB, tetrapropylammonium hydroxide, tetrapropylammonium bromide, hexylene glycol, butylamine, ethylamine.

The mineral synthesis method specifically includes the following steps:

(1) mineral activation: aluminum source, silicon source, iron source and copper source are activated respectively;

(2) the activated mineral is mixed with sodium hydroxide, deionized water and seed crystals, wherein the molar ratio of each substance in the synthetic system is SiO₂/Al₂O₃=10˜∞, SiO₂/Fe₂O₃=10˜350, SiO₂/CuO=10˜150, Na₂O/SiO₂=0.1˜0.5, H₂O/SiO₂=10˜50, templating agent/SiO₂=0.01˜0.5; after mixing, add the acid source to adjust the system pH to 5˜13 to carry out aging, that is, obtain the aging gel,

(3) the aged gel obtained in the step (2) is transferred to a Teflon-lined reaction kettle for sealing crystallization, after crystallization, the product is cooled, filtered to remove the mother liquid, and the filter cake is washed with deionized water to neutrality, dried to obtain a solid, and then which the solid is passed through ion-exchange, filtered, washed, and dried to obtain a powder;

wherein the drying condition is 80-150° C., drying overnight;

(4) the powder obtained in the step (2) is placed in a muffle furnace and calcined to obtain a mesoporous FeCu—ZSM-5 molecular sieve.

Wherein the iron source is one or more of bauxite, diatomaceous earth, rectorite, pyrite, mica hematite, and red mud.

the copper source is one or more of magnetite, malachite, copper blue, and chalcopyrite.

the acid source is one or more of 2-Hydroxy-1,2,3-propanetricarboxylic acid, sulfurous acid, nitrous acid, sulfuric acid, hydrochloric acid, nitric acid, oxalic acid, acetic acid.

the silicon source is one or two of bauxite, diatomaceous earth, rectorite, natural zeolite or opal.

the aluminum source is one or more of mica, alumite, bauxite, diatomaceous earth, rectorite, natural zeolite.

the templating agent is tetraoctyl ammonium bromide, tetrabutylammonium bromide, CTMAB, tetrapropylammonium hydroxide, tetrapropylammonium bromide, hexylene glycol, butylamine, ethylamine.

Wherein aging is carried out at 60-90° C. for 2-12 h; the crystallization is carried out at 100-190° C. for 12-96 h.

Wherein the method for ion-exchange is as follows: mixing the dried solid with 0.1˜2 M NH₄Cl solution according to a mass ratio of 1:10 to 1:30 for ion exchange, and heating and stirring at 10˜80° C. for 3˜8 h.

Wherein the calcination is carried out at 500˜600° C. for 4˜10 h.

Further, the prepared FeCu—ZSM-5 catalyst is applied to a selective catalytic reduction reaction of nitrogen oxides.

In summary, the present invention provides a FeCu—ZSM-5 molecular sieve and a synthesis method thereof. The FeCu—ZSM-5 molecular sieve of the present invention has the following advantages:

(1) The invention overcomes the disadvantages of the cumbersome steps and high cost of the conventional impregnation or ion exchange preparation method. This method uses a one-pot method of segmentally regulating the pH value of the synthesis system to synthesize mesoporous FeCu—ZSM-5 molecular sieve in situ, and ion exchange can be performed without removing the microporous template. The invention can synthesize mesoporous FeCu—ZSM-5 molecular sieve with excellent SCR denitration performance economically and environmentally. This molecular sieve has a higher NO conversion of 90% and a higher N₂ selectivity (>99%) over a wide temperature window (150-700° C.).

(2) The invention solves the defects that the traditional impregnation method has the advantages of complicated process, long process, easy agglomeration of Fe or Cu, and long synthesis cycle. At the same time, the use of a (large) pore templating agent is avoided. This method effectively alleviates the release of a large amount of contaminated gas such as ammonia gas during demolding, and effectively avoids the damage caused by the removal of the template agent to the pores of the molecular sieve itself. In a short period of time, mesoporous FeCu—ZSM-5 molecular sieve with excellent SCR denitrification performance can be synthesized economically, environmentally and efficiently.

(3) The FeCu—ZSM-5 prepared by the method of the invention belongs to a ladder pore catalytic material. Its molar silicon to aluminum ratio is 10˜∞. It has the advantages of large specific surface area, large adsorption capacity and rich acidity, which is beneficial to the sufficient contact of the reactive substance with the active site. At the same time, it also solves the problem of traditional microporous molecular sieves such as internal mass transfer and diffusion.

(4) The synthetic route provided by the invention can not only greatly reduce the production cost of molecular sieve synthesis, but also greatly improve the greenness of the synthesis process. The obtained molecular sieve has superior physicochemical properties and is low in cost.

(5) The mesoporous distribution of the molecular sieve prepared in the short cycle is concentrated at 5˜50 nm, the specific surface area is 380˜700 m²/g, and the external specific surface area is 120˜400 m²/g. The content of Fe₂O₃ in the molecular sieve is 0.1˜10% of the total weight of the molecular sieve, wherein the content of Fe in the skeleton accounts for more than 95% of the total iron content, and is uniformly distributed in the skeleton. The content of CuO in the molecular sieve is 0.1˜10% of the total weight of the molecular sieve, wherein the content of Cu²⁺ accounts for more than 90% of the total copper content, and its distribution on the inner surface of the molecular sieve is uniform.

### BRIEF DESCRIPTION OF THE DRAWINGS

FIG. 1 is an X-ray diffraction (XRD) spectrum of a FeCu—ZSM-5 molecular sieve prepared in Example 1 of the present invention.

FIG. 2 is an N₂ adsorption-desorption isotherm of the FeCu—ZSM-5 molecular sieve prepared in Example 1 of the present invention.

### DESCRIPTION OF THE PREFERRED EMBODIMENTS

The embodiments of the present invention and the beneficial effects thereof are described in detail below by way of specific examples, which are intended to provide a better understanding of the nature and features of the present invention.

### Embodiment 1

1.32 g Fe(NO₃)₃.9H₂O, 0.26 g Cu(NO₃)₂.3H₂O, 36.55 g H₂O, 1.473 g TPABr, 14.18 g water glass (27.6 wt % SiO₂), 2.2 g 2-hydroxy-propanetricarboxylic acid were mixed in the beaker. Then adjust the pH to 12, aging at 30° C. for 4 h, then 1.2 g 2-hydroxy-1-propanetricarboxylic acid was added to adjust the pH to 9 and age for 4 h under 70° C. The above product was then transferred to stainless steel autoclave lined with PTFE and crystallized at 170° C. for 48 h. After crystallization, the crystallized product was cooled, filtered and washed to neutrality, and then placed in an oven at 120° C. overnight to obtain a sodium type molecular sieve.

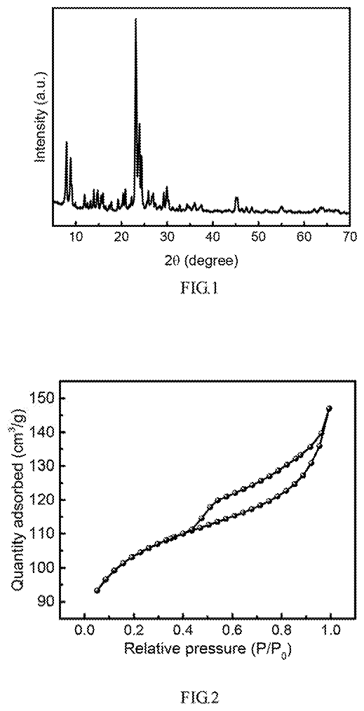

The sodium type molecular sieve and the 1 M NH₄Cl solution were ion-exchanged at a mass ratio of 1:20, stirred in a constant temperature water bath at 70° C. for 4 h, then filtered, washed, dried, and calcined at 520° C. for 5 h. That is, a hydrogen type FeCu—ZSM-5 molecular sieve was prepared and recorded as Catalyst A. FIG. 1 and FIG. 2 are the XRD and an N₂ adsorption-desorption isotherm of the FeCu—ZSM-5 molecular sieve, respectively. As can be seen from FIG. 1, the obtained product was a high crystallinity ZSM-5 molecular sieve. It can be seen from FIG. 2 that the obtained sample contains obvious mesopores, wherein the mesoporous pore size is mainly concentrated at 10 nm, the specific surface area is 441 m²/g, the external specific surface area is 151 m²/g, and the Fe₂O₃ content is 3.1% of the total weight of the molecular sieve, wherein the Fe content in the skeleton accounts for 96% of the total iron content. The CuO content is 1.8% of the total weight of the molecular sieve, wherein Cu²⁺ accounts for 91% of the total copper content.

### Embodiment 2

This embodiment provides a FeCu—ZSM-5 catalyst, and the preparation steps are the same as those in the Embodiment 1, and only some parameters are modulated, as follows:

Molecular sieve preparation: 2.18 g Fe(NO₃)₃.9H₂O, 0.13 g Cu(NO)₂.3H₂O, 10 g H₂O, 5.20 g CTAB, 1.069 g sodium aluminate, 14.18 g water glass (27.6 wt % SiO₂), 2.2 g sulfuric acid were mixed in the beaker. Then adjust the pH to 11, aging at 40° C. for 2 h, then 1.2 g sodium aluminate was added to adjust the pH to 8 and age for 4 h under 80° C. The above product was then transferred to stainless steel autoclave lined with PTFE and crystallized at 160° C. for 24 h. After crystallization, the crystallized product was cooled, filtered and washed to neutrality, and then placed in an oven at 120° C. overnight to obtain a sodium type molecular sieve.

The sodium type molecular sieve and the 1 M NH₄Cl solution were ion-exchanged at a mass ratio of 1:20, stirred in a constant temperature water bath at 70° C. for 4 h, then filtered, washed, dried, and calcined at 530° C. for 5 h. That is, a hydrogen type FeCu—ZSM-5 molecular sieve was prepared and recorded as Catalyst B. The mesoporous pore size of product is mainly concentrated at 15 nm, the specific surface area is 470 m²/g, the external specific surface area is 160 m²/g, and the Fe₂O₃ content is 5.4% of the total weight of the molecular sieve, wherein the Fe content in the skeleton accounts for 95.5% of the total iron content. The CuO content is 0.7% of the total weight of the molecular sieve, wherein Cu²⁺ accounts for 90% of the total copper content.

### Embodiment 3

This embodiment provides a FeCu—ZSM-5 catalyst, and the preparation steps are the same as those in the Embodiment 1, and only some parameters are modulated, as follows:

Molecular sieve preparation: 5.2 g Fe(NO₃)₃.9H₂O, 0.11 g Cu(NO₃)₂.3H₂O, 18.3 g H₂O, 8.67 g TPABr, 12.27 g aluminum sulfate, 14.18 g water glass (27.6 wt % SiO₂), 2.2 g sulfuric acid were mixed in the beaker. Then adjust the pH to 13, aging at 50° C. for 5 h, then 3.2 g sodium aluminate was added to adjust the pH to 7 and age for 6 h under 60° C. The above product was then transferred to stainless steel autoclave lined with PTFE and crystallized at 170° C. for 48 h. After crystallization, the crystallized product was cooled, filtered and washed to neutrality, and then placed in an oven at 90° C. overnight to obtain a sodium type molecular sieve.

The sodium type molecular sieve and the 1 M NH₄Cl solution were ion-exchanged at a mass ratio of 1:15, stirred in a constant temperature water bath at 70° C. for 3 h, then filtered, washed, dried, and calcined at 550 T for 7 h. That is, a hydrogen type FeCu—ZSM-5 molecular sieve was prepared and recorded as Catalyst C. The mesoporous pore size of product is mainly concentrated at 30 nm, the specific surface area is 550 m²/g, the external specific surface area is 300 m²/g, and the Fe₂O₃ content is 9.4% of the total weight of the molecular sieve, wherein the Fe content in the skeleton accounts for 97% of the total iron content. The CuO content is 0.6% of the total weight of the molecular sieve, wherein Cu²⁺ accounts for 90% of the total copper content.

### Embodiment 4

This embodiment provides a FeCu—ZSM-5 catalyst, and the preparation steps are the same as those in the Embodiment 1, and only some parameters are modulated, as follows:

Activation of minerals: Commercially available diatomaceous earth was dried, pulverized into powder, and 50.00 g of diatomaceous earth powder was calcined at 800° C. for 4 h. Then, 60.00 g of soil, 6 g of sodium hydroxide, and 300 g of water were mechanically stirred at room temperature for 1 h, then activated in an oven at 255° C. for 12 h, and then pulverized for use.

Molecular sieve preparation: 0.79 g of sodium hydroxide, mixed with 52.2 g of deionized water, then added 0.30 g of Cu(NO₃)₂H₂O, 4.7 g of thermally activated diatomite, 0.24 g of activated retentive soil, 0.52 g of n-butylamine. Then, 2 g of hydrochloric acid was added to adjust the pH to 13, transferred to a 60° C. water bath for 30 min, 0.5 g of hydrochloric acid was added to adjust the pH to 12, and the mixture was aged for 4 h in a 70° C. water bath. The above product was then transferred to stainless steel autoclave lined with PTFE and crystallized at 170° C. for 72 h. After crystallization, the crystallized product was cooled, filtered and washed to neutrality, and then placed in an oven at 110° C. overnight to obtain a sodium type molecular sieve.

The sodium type molecular sieve and the 1 M NH₄Cl solution were ion-exchanged at a mass ratio of 1:30, stirred in a constant temperature water bath at 80° C. for 4 h, then filtered, washed, dried, and calcined at 560° C. for 8 h. That is, a hydrogen type FeCu—ZSM-5 molecular sieve was prepared and recorded as Catalyst D. The mesoporous pore size of product is mainly concentrated at 35 nm, the specific surface area is 470 m²/g, the external specific surface area is 215 m²/g, and the Fe₂O₃ content is 1% of the total weight of the molecular sieve, wherein the Fe content in the skeleton accounts for 98% of the total iron content. The CuO content is 0.87% of the total weight of the molecular sieve, wherein Cu²⁺ accounts for 93% of the total copper content.

### Embodiment 5

In this embodiment, the catalyst prepared in Embodiment 1 is used for the fixed bed reaction test activity, and includes the following steps: After the catalyst A obtained in Example 1 was tableted and sieved, catalyst particles of 20 to 40 mesh were taken for activity evaluation. The activity evaluation device for the catalyst is a normal pressure type micro fixed bed reaction device, which is composed of a gas mixing preheating furnace and a reaction furnace, and the reactor is a quartz tube having an inner diameter of 7 mm. During the experiment, the reaction was carried out by means of temperature-programming, and the temperature of the heating furnace was controlled by a temperature controller. When the data collection point is reached, stay for 30 minutes for data processing and record data. Reaction conditions: 500 ppm NO, 500 ppm NH₃, 5 v % O₂, N₂ is the equilibrium gas, the total gas flow rate is 600 mL/min, the catalyst dosage is 200 mg, and the reaction volume space velocity is 180,000 h⁻¹. The concentrations of NO, NH₃ and NO₂ were qualitatively and quantitatively analyzed by a flue gas analyzer (testo340, Germany). The concentration of N₂O was measured by a Fourier transform infrared spectrometer (Nicolet iS50) equipped with a 2 m optical path gas cell.

### Embodiment 6

In this embodiment, the catalyst was used for the fixed bed reaction test activity, and the procedure was the same as in Embodiment 5. The parameters differed in that the catalyst was replaced by Catalyst B prepared in Embodiment 2.

### Embodiment 7

In this embodiment, the catalyst was used for the fixed bed reaction test activity, and the procedure was the same as in Embodiment 5. The parameters differed in that the catalyst was replaced by Catalyst C prepared in Embodiment 3.

### Embodiment 8

In this embodiment, the catalyst was used for the fixed bed reaction test activity, and the procedure was the same as in Embodiment 5. The parameters differed in that the catalyst was replaced by Catalyst D prepared in Embodiment 4.

### Embodiment 9

In this embodiment, the catalyst was used for the fixed bed reaction test activity, and the procedure was the same as in Embodiment 5. The difference in parameters is that the catalyst is Catalyst E which is obtained by hydrothermal treatment of Catalyst D at 700° C. for 4 h.

### Contrast Embodiment 1

(1) In order to demonstrate the technical effects of the present invention, the present invention also provides a comparative example, and the molecular sieve used in the present comparative example is a commercial HZSM-5 purchased by Nankai Catalyst Factory.

(2) 0.62 g Cu(NO₃)₂.3H₂O, 3.22 g of Fe(NO₃)₃.9H₂O, and 5 g of deionized water were uniformly mixed, and then slowly added dropwise to 10 g of the molecular sieve in the step (1). Then, it was sonicated for 2 h, air-dried at room temperature, placed in an oven at 120° C. for 8 h, finally calcined at 520° C. for 5 h in a muffle furnace, cooled to room temperature and recorded as catalyst F.

After the catalyst F was tableted and sieved, catalyst particles of 20 to 40 mesh were taken for activity evaluation. The activity evaluation device for the catalyst is a normal pressure type micro fixed bed reaction device, which is composed of a gas mixing preheating furnace and a reaction furnace, and the reactor is a quartz tube having an inner diameter of 7 mm. During the experiment, the reaction was carried out by means of temperature-programming, and the temperature of the heating furnace was controlled by a temperature controller. When the data collection point is reached, stay for 30 minutes for data processing and record data. Reaction conditions: 500 ppm NO, 500 ppm NH₃, 5 v % O₂, N₂ is the equilibrium gas, the total gas flow rate is 600 mL/min, the catalyst dosage is 200 mg, and the reaction volume space velocity is 180,000 h⁻¹. The concentrations of NO, NH₃ and NO₂ were qualitatively and quantitatively analyzed by a flue gas analyzer (testo340, Germany). The concentration of N₂O was measured by a Fourier transform infrared spectrometer (Nicolet iS50) equipped with a 2 m optical path gas cell.

### Contrast Embodiment 2

In order to demonstrate the technical effects of the present invention, the present invention also provides a comparative example, and the molecular sieve used in the present comparative embodiment is Catalyst G which is obtained by hydrothermal treatment of the commercial HZSM-5 at 700° C. for 4 h.

After the catalyst G was tableted and sieved, catalyst particles of 20 to 40 mesh were taken for activity evaluation. The activity evaluation device for the catalyst is a normal pressure type micro fixed bed reaction device, which is composed of a gas mixing preheating furnace and a reaction furnace, and the reactor is a quartz tube having an inner diameter of 7 mm. During the experiment, the reaction was carried out by means of temperature-programming, and the temperature of the heating furnace was controlled by a temperature controller. When the data collection point is reached, stay for 30 minutes for data processing and record data. Reaction conditions: 500 ppm NO, 500 ppm NH₃, 5 v % 02, N₂ is the equilibrium gas, the total gas flow rate is 600 mL/min, the catalyst dosage is 200 mg, and the reaction volume space velocity is 180,000 h⁻¹. The concentrations of NO, NH₃ and NO₂ were qualitatively and quantitatively analyzed by a flue gas analyzer (testo340, Germany). The concentration of N₂O was measured by a Fourier transform infrared spectrometer (Nicolet iS50) equipped with a 2 m optical path gas cell.

TABLE 1
Measurement results of various examples
and fixed bed reaction test activities

| | Temperature window | N₂ selectivity |
|---|---|---|
| | (° C.) | (%) |
| Embodiment 5 | 200-700 | >99.0 |
| Embodiment 6 | 175-700 | >99.0 |
| Embodiment 7 | 180-700 | >99.5 |
| Embodiment 8 | 150-700 | >99.5 |
| Embodiment 9 | 210-700 | >99.0 |
| Contrast Embodiment 1 | 400-500 | <90.0 |
| Contrast Embodiment 2 | 450-500 | <85.0 |

Note:
The temperature window is the corresponding temperature range when the conversion rate of NO is >90%.

As can be seen from Table 1, the mesoporous FeCu—ZSM-5 provided by the present invention has an ultra-wide temperature window (especially low temperature activity), excellent N2 selectivity and good hydrothermal stability. The method of the invention not only has the advantages of low cost, simple process, simple operation, but also good economic and environmental benefits.

While the invention has been described hereinabove, the invention is not limited to the specific embodiments described herein. Many modifications may be made by those skilled in the art without departing from the spirit and scope of the invention.

What is claimed is:

1. A mesoporous FeCu—ZSM-5 molecular sieve, comprising: deionized water, aluminum source, silicon source, iron source, copper source, acid source and templating agents; the content of Fe2O3 in the molecular sieve is 0.1˜10% of the total weight of the molecular sieve, wherein the content of Fe in skeleton accounts for more than 95% of the total iron content, and is evenly distributed in the framework; the CuO content in the molecular sieve is 0.1˜10% of the total weight of the molecular sieve, wherein the content of Cu2+ accounts for more than 90% of the total copper content, and is evenly distributed on the inner surface of the molecular sieve.

2. A process for producing mesoporous FeCu—ZSM-5 molecular sieve, comprising: a chemical reagent synthesis method or a mineral synthesis method.

3. The process according to claim 2, wherein the chemical reagent synthesis method specifically includes the following steps:
(1) the deionized water, aluminum source, silicon source, iron source, copper source and templating agent are uniformly mixed under stirring conditions at 20-90° C., wherein the molar ratio of each substance in the synthetic system is SiO₂/Al₂O₃=10˜∞, SiO₂/Fe₂O₃=10˜350, SiO₂/CuO=10˜150, Na₂O/SiO₂=0.1˜0.5, H₂O/SiO₂=10˜50, templating agent/SiO₂=0.01˜0.5; after mixing, add the acid source to adjust the system pH to 5˜13 to carry out the first aging, then add the acid source again, adjust the system pH to 5˜13 to carry out the second aging, that is, obtain the aging gel,
(2) the aged gel obtained in the step (1) is transferred to a Teflon-lined reaction kettle for sealing crystallization, after crystallization, the product is cooled, filtered to remove the mother liquid, and the filter cake is washed with deionized water to neutrality, dried to obtain a solid, and then which the solid is passed through ion-exchange, filtered, washed, and dried to obtain a powder;
wherein the drying condition is 80-150° C., drying overnight;
(3) the powder obtained in the step (2) is placed in a muffle furnace and calcined to obtain a mesoporous FeCu—ZSM-5 molecular sieve.

4. The process according to claim 3, wherein
the iron source is one or more of ferric nitrate, ferric chloride and ferric sulfate,
the copper source is one or more of copper nitrate, copper nitrate trihydrate, copper nitrate nonahydrate and copper chloride dihydrate,
the acid source is one or more of 2-Hydroxy-1,2,3-propanetricarboxylic acid, sulfurous acid, nitrous acid, sulfuric acid, hydrochloric acid, nitric acid, oxalic acid, acetic acid,
the silicon source is one or more of water glass, silica sol, tetraethyl orthosilicate, solid silica gel,
the aluminum source is one or more of sodium aluminate and aluminum sulfate,
the templating agent is tetraoctyl ammonium bromide, tetrabutylammonium bromide, CTMAB, tetrapropylammonium hydroxide, tetrapropylammonium bromide, hexylene glycol, butylamine, ethylamine.

5. The process according to claim 2, wherein the mineral synthesis method specifically includes the following steps:
(1) mineral activation: aluminum source, silicon source, iron source and copper source are activated respectively;
(2) the activated mineral is mixed with sodium hydroxide, deionized water and seed crystals, wherein the molar ratio of each substance in the synthetic system is SiO₂/Al₂O₃=10˜∞, SiO₂/Fe₂O₃=10˜350, SiO₂/CuO=10˜150, Na₂O/SiO₂=0.1˜0.5, H₂O/SiO₂=10˜50, templating agent/SiO₂=0.01˜0.5; after mixing, add the acid source to adjust the system pH to 5˜13 to carry out aging, that is, obtain the aging gel,
(3) the aged gel obtained in the step (2) is transferred to a Teflon-lined reaction kettle for sealing crystallization, after crystallization, the product is cooled, filtered to remove the mother liquid, and the filter cake is washed with deionized water to neutrality, dried to obtain a solid, and then which the solid is passed through ion-exchange, filtered, washed, and dried to obtain a powder,
wherein the drying condition is 80-150° C., drying overnight;
(4) the powder obtained in the step (2) is placed in a muffle furnace and calcined to obtain a mesoporous FeCu—ZSM-5 molecular sieve.

6. The process according to claim 5, wherein
the iron source is one or more of bauxite, diatomaceous earth, rectorite, pyrite, mica hematite, and red mud,
the copper source is one or more of magnetite, malachite, copper blue, and chalcopyrite,
the acid source is one or more of 2-Hydroxy-1,2,3-propanetricarboxylic acid, sulfurous acid, nitrous acid, sulfuric acid, hydrochloric acid, nitric acid, oxalic acid, acetic acid,
the silicon source is one or two of bauxite, diatomaceous earth, rectorite, natural zeolite or opal,
the aluminum source is one or more of mica, alumite, bauxite, diatomaceous earth, rectorite, natural zeolite,
the templating agent is tetraoctyl ammonium bromide, tetrabutylammonium bromide, CTMAB, tetrapropylammonium hydroxide, tetrapropylammonium bromide, hexylene glycol, butylamine, ethylamine.

7. The process according to claim 3 or claim 5, wherein aging is carried out at 60-90° C. for 2-12 h; the crystallization is carried out at 100-190° C. for 12-96 h.

8. The process according to claim 3 or claim 5, wherein the method for ion-exchange is as follows: mixing the dried solid with 0.1˜2 M NH₄Cl solution according to a mass ratio of 1:10 to 1:30 for ion exchange, and heating and stirring at 10˜80° C. for 3˜8 h.

9. The process according to claim 3 or claim 5, wherein the calcination is carried out at 500˜600° C. for 4˜10 h.

10. The application of mesoporous FeCu—ZSM-5 molecular sieve according to any of the claims 1-9 in the selective catalytic reduction of nitrogen oxides.
